(19) United States
(12) Patent Application Publication
(10) Pub. No.: US 2024/0274863 A1
(43) Pub. Date: Aug. 15, 2024

(54) METHOD FOR PRODUCING A BATTERY MODULE, AND BATTERY MODULE

(71) Applicant: Robert Bosch GmbH, Stuttgart (DE)

(72) Inventors: Andreas Ruehle, Bietigheim-Bissingen (DE); Jens-Martin Koegel, Stuttgart (DE); Joerg Nils Illig, Markgroeningen (DE); Klaus Spieske, Stuttgart (DE); Knut Hanke, Neuhausen (DE); Martin Kassner, Weil Der Stadt (DE); Nils Ohmer, Stuttgart (DE); Ruben Jung, Stuttgart (DE)

(21) Appl. No.: 18/436,912

(22) Filed: Feb. 8, 2024

(30) Foreign Application Priority Data
Feb. 13, 2023 (DE) 10 2023 201 141.7

(51) Int. Cl. H01M 10/04; H01M 10/0525; H01M 50/103; H01M 50/105; H01M 50/289

(52) U.S. Cl. CPC H01M 10/0481; H01M 50/103; H01M 50/105; H01M 50/289; H01M 10/0525

(57) ABSTRACT

A method for producing a battery module including a plurality of prismatic battery cells and/or a plurality of battery cells in the form of pouch cells includes, in a first method step, a force acting on a respective battery cell is detected in order to form a defined width of the battery cell. In a second method step, the plurality of battery cells are arranged adjacent to one another in a longitudinal direction of the battery module, and a compensating element is furthermore arranged between two battery cells arranged directly adjacent to one another. A width and/or a deformability of the compensating element is formed such that, when a defined total width of the battery module is formed, a defined force acts on a respective battery cell.

### BACKGROUND

The invention is based on a method for producing a battery module.

Another object of the present invention is a battery module.

It is known from the prior art for a battery module to comprise a plurality of individual battery cells, each comprising a positive voltage tap and a negative voltage tap. In this context, with regard to an electrically conductive serial and/or parallel connection of the plurality of battery cells to one another, the respective voltage taps are connected to one another in an electrically conductive manner and can therefore be interconnected to form the battery module. In particular, the battery cells can each comprise a first voltage tap, in particular a positive voltage tap, and a second voltage tap, in particular a negative voltage tap, which taps are electroconductively connected to one another by means of cell connectors so that an electroconductive serial and/or parallel circuitry is formed. Battery modules are themselves in turn interconnected into batteries or entire battery systems.

### SUMMARY

A method for producing a battery module with the features of the disclosure offers the advantage that a defined force on the individual battery cells of the battery module can be formed, in particular even if the individual battery cells each have a different deformation behavior when used in the battery module.

According to the invention, a method for producing a battery module comprising a plurality of prismatic battery cells and/or a plurality of battery cells in the form of pouch cells is provided for this purpose. In particular, the battery cells are in this case designed as lithium-ion battery cells.

In a first method step, a force is thereby detected which acts on a respective battery cell to form a defined width of this battery cell.

Furthermore, in a second method step, the plurality of battery cells is thereby arranged adjacent to each other in a longitudinal direction of the battery module. A compensating element is also arranged between two directly adjacent battery cells. A width of the compensating element and/or a deformability of the compensating element is in this case designed such that a defined force acts on a respective battery cell when a defined total width of the battery module is formed.

In particular, the first method step of detecting the force acting on a respective battery cell to form a defined width can be performed before and, among other things, spatially separated from the second method step of arranging the plurality of battery cells adjacent to one another in a longitudinal direction of the battery module, and arranging the compensating element between two battery cells arranged directly adjacent to one another and forming the compensating element. For example, the first method step could be performed at a manufacturer or supplier of the battery cells. It should also be noted that force acting on each battery cell is preferably detected to form the defined width.

Furthermore, the second method step could, e.g., be performed at a manufacturer or supplier of the battery module. It should also be noted that the force acting on each battery cell is preferably read out to form the defined width.

In particular, the defined width can be a reference width of the battery cell, which, e.g., can be generally defined for certain battery cell types. Furthermore, the force that forms a defined width or a reference width that is identical for all battery cells could be detected for each battery cell. If the battery cell is not compressed to an identical width by the force, then it is also possible to determine a factor from the applied force and defined width, e.g. by means of a multiplication sum.

It should at this point be noted that prismatic battery cells each comprise a battery cell housing having a total of six lateral surfaces, which are arranged in pairs opposite each other and substantially parallel to each other. In addition, lateral surfaces arranged adjacent one another are arranged perpendicular to one another. The electrochemical components of the respective battery cell are accommodated within the interior of the battery cell housing. Typically, two voltage taps, in particular a positive voltage tap and a negative voltage tap, are arranged on an upper lateral surface, which is referred to as the cover surface. The lower lateral surface opposite the upper lateral surface is referred to as the bottom surface.

It should also be noted at this point that in battery cells designed as pouch cells, which can also be referred to as pouch cells in particular, a film encloses an interior in which the electrochemical components of the respective battery cell are accommodated. Two voltage taps, in particular a positive voltage tap and a negative voltage tap, are in this case fed through this foil from the inside. Such battery cells designed as pouch cells also essentially have six lateral surfaces.

Furthermore, it should be noted in this respect that, when the battery cells are arranged next to each other in a longitudinal direction of the battery module, the respective largest lateral surfaces of the battery cells are arranged adjacent to each other, which lateral surfaces are each arranged in particular at right angles to the upper lateral surface and the lower lateral surface. It should be noted at this point that the longitudinal direction of the battery module in this case is therefore advantageously arranged perpendicular to the largest lateral surfaces of the respective battery cells.

It should also be noted that the width of a respective battery cell is preferably formed by the distance between the two largest lateral surfaces. In other words, this width could, e.g., also be referred to as the thickness of a battery cell.

The width formed by the acting force can in this case preferably be selected in particular such that air inclusions and/or cavities in an interior of the battery cell are reliably compensated or compressed and therefore enable a reliable arrangement in the battery module without further tolerances occurring.

It is advantageous if the force acts on the largest lateral surfaces of the respective battery cell. As a result, it is possible to reliably measure and therefore detect the respective force to form a defined width of each battery cell.

It is also advantageous if the force is applied by means of two plates. in this case, the respective battery cell is arranged between the two plates. As a result, the force can be applied reliably. A defined width can therefore be reliably formed using the applied force. It should be noted at this point that the force can in this case be applied by means of both plates being actively moved towards each other, or that the force can in this case be actively applied to another stationary plate by means of the movement of one of the plates. In particular, the two plates in each case could be planar and arranged parallel to each other. Furthermore, the two plates can in particular also feature any desired geometric designs, such as a pressed geometry in which, e.g., the battery cell can be accommodated.

It is advantageous if, in the first method step, the respective force acting on a battery cell is also stored as belonging to this respective battery cell and, in the second method step, the respective force applied to a battery cell is also read out and associated with this respective battery cell. As a result, the temporal separation and spatial separation of the first method step and the second method step are further assisted such that a direct and unambiguous association of a correct force acting on the respective battery cell is always possible.

It is advantageous if the respective force acting on a battery cell is stored in a database or on the battery cell. As a result, the reliable, direct, and unambiguous association of a correct force acting on the respective battery cell is further improved. For example, the force applied to form a defined width of the battery cell together with the defined width could be applied to the packaging of the battery cell or directly to the housing of the battery cell.

According to one preferred aspect of the invention, compensating elements are having different widths and/or having different deformabilities are arranged.

A first compensating element having a first width and/or having a first deformability is in this case arranged between two battery cells, whose applied forces form a first sum.

Furthermore, a second compensating element having a second width and/or having a second deformability is in this case arranged between two battery cells, whose applied forces form a second sum. The first sum is in this case greater than the second sum and the first width is smaller than the second width or the first deformability is smaller than the second deformability.

As a result, it is possible to select the compensating element depending on the detected forces acting on the two battery cells arranged directly adjacent to each other. In particular, the compensating element can in this case be designed such that a comparably thinner compensating element is arranged between comparably force-resistant battery cells, which are to be compressed by a comparably greater force, and that a comparably thicker compensating element can be arranged between comparably force-sensitive battery cells, which are to be compressed by a comparably smaller force.

It should be noted at this point that the number of compensating elements having different widths and/or having different deformabilities can,, e.g., comprise two or three different compensating elements. In particular, the number of compensating elements having different widths and/or having different deformabilities can also be adapted to production-related deviations in the detected forces acting on the battery cells to form the defined width so that, e.g., a comparably larger number of different compensating elements can be selected when a comparably large number of different forces acting on the battery cells are detected.

For example, the different compensating elements could also be selected such that an average width of all compensating elements and/or average deformability is formed.

According to another preferred aspect of the invention, compensating elements having identical widths and/or having identical deformabilities are arranged. In this context, a total force is first determined, which is the sum of all the forces detected and acting on the respective battery cells. Depending on the defined total width of the battery module, the identical widths of the compensating elements and/or the identical deformabilities of the compensating elements are calculated.

According to yet another preferred aspect of the invention, forming the total force further comprises calculating an average applied force. At this point, it should be noted that the average force corresponds to the total sum of all detected applied forces divided by the number of battery cells. Furthermore, the total force is calculated by multiplication as the product of the average force and the number of battery cells.

Another object of the present invention is a battery module comprising a plurality of battery cells, which are designed in particular as lithium-ion battery cells. The battery module is in this case produced according to the method of the invention just described.

It should also be noted at this point that the battery cells can also be designed as sodium-ion battery cells.

### BRIEF DESCRIPTION OF THE DRAWINGS

Exemplary embodiments of the invention are illustrated in the drawings and explained in greater detail in the subsequent description.

Shown are:

FIG. 1 a first method step of a method according to the invention for producing a battery module,

FIG. 2 an embodiment of a first battery module according to the invention after performing a second method step and

FIG. 3 an embodiment of a second battery module according to the invention after performing a second method step.

### DETAILED DESCRIPTION

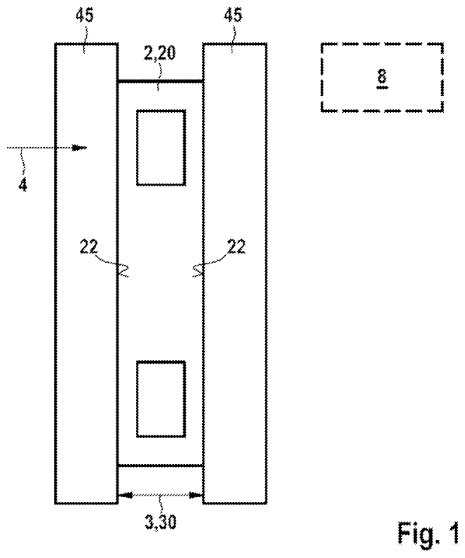

FIG. 1 shows a first method step of a method according to the invention for producing a battery module 1.

Apparent in this case is a prismatic battery cell 2 which, according to the exemplary embodiment shown in FIG. 1, is designed in particular as a lithium-ion battery cell 20.

In the first method step shown in FIG. 1, a force 4 is detected which acts on the battery cell 2 in order to form a defined width 3 of this battery cell 2. The battery cell 2 shown in FIG. 1 has a defined width 30 when the force 4 is applied.

In particular, it can be seen from FIG. 1 that the force 4 in each case acts on the largest lateral surfaces 22 of the battery cell 2. In particular, the force 4 can preferably be applied by means of two plates 45. The battery cell 2 is arranged between the two plates 45.

Furthermore, in such a first method step, the respective force 4 acting on the battery cell 2 is stored associated with this respective battery cell 2. For example, the force 4 applied to the battery cell 2 of this respective battery cell 2 can be stored in a database 8 and/or also preferably directly on the battery cell 2. It is further possible to also store the defined width 30 which has been formed by means of the force 4.

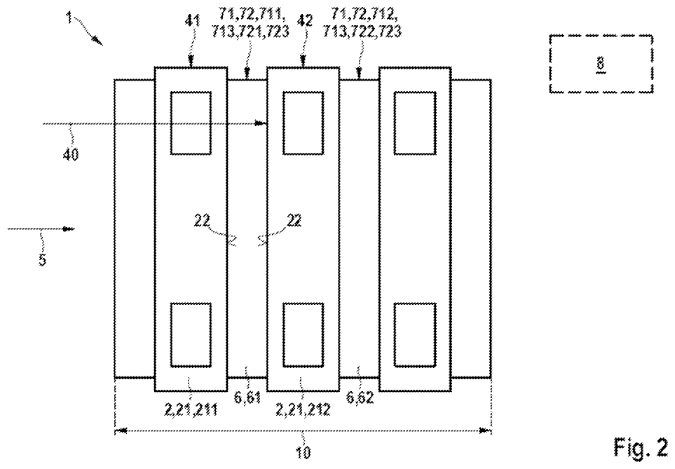

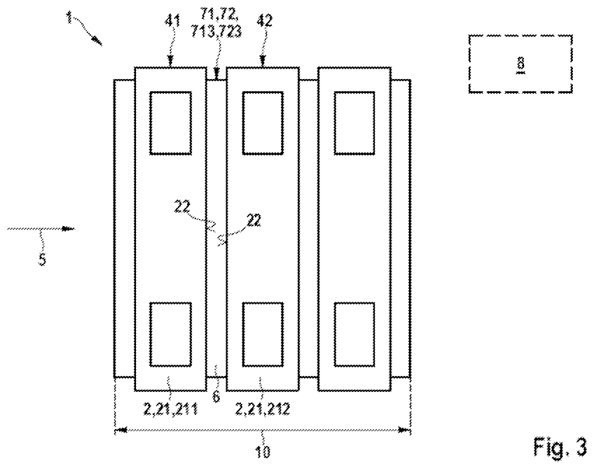

FIG. 2 shows an embodiment of a first battery module 1 according to the invention comprising a plurality of battery cells 2 after performing a second method step, and FIG. 3 shows an embodiment of a second battery module 1 according to the invention comprising a plurality of battery cells 2 after performing a second method step.

FIGS. 2 and 3 are intended to mostly be described together hereinafter.

In this case can be seen that the plurality of battery cells 2 are arranged adjacent to each other in a longitudinal direction 5 of the respective battery module 1. In particular, the respective largest lateral surfaces 22 of the battery cells 2 are in this case arranged adjacent to each other.

Furthermore, a compensating element 6, which has a width 71 and a deformability 72, is arranged between two battery cells 21 arranged directly adjacent to each other. FIGS. 2 and 3 also show that, in each case, a further compensating element 6 can be arranged adjacent to opposite terminal battery cells 2.

The width 71 of the compensating element 6 and/or the deformability 72 of the compensating element 6 are in this case designed such that a defined force 40 acts on a respective battery cell 2 when a defined total width 10 of the battery module 1 is formed.

In particular, a first force 41 acting on, e.g., a first battery cell 211 of the two battery cells 21 arranged directly adjacent to one another and a second force 42 acting on a second battery cell 212 of the two battery cells 21 arranged directly adjacent to one another. Furthermore, it should be noted in particular that the width 71 of the compensating element 6 can correspond to the distance between the largest lateral surfaces 22 of the two battery cells 21 arranged directly adjacent to each other.

In particular, the force 4 acting on a battery cell 2 can be read out in the second method step and associated with this respective battery cell 2, e.g. from a database 8. Furthermore, the defined width 30 can also be read out. Furthermore, the width 30 and the applied force 4 can be linked to one another by means of a formula.

In particular, FIGS. 2 and 3 each show that compensating elements 6 having identical widths 713 and identical deformabilities 723 are arranged. For this purpose, a total force is first determined, which is formed as the sum of all forces 4 of the plurality of battery cells 2 acting on the respective battery cells 2. The identical width 713 and the identical deformability 723 are then determined as a function of the defined total width 10 of the battery module 1.

It should be noted at this point that the formation of the total force can also comprise the calculation of an average force 4. Furthermore, the defined total force is then calculated as the product of the average force 4 and the number of battery cells 2.

The embodiments of the battery module 1 according to the invention shown in FIGS. 2 and 3 differ in particular in that the battery cells 2 of the battery module 1 according to FIG. 1 have a smaller applied force 4 than the battery cells 2 of the battery module 1 according to FIG. 2. As a result, the compensating elements 6 of the battery module 1 according to FIG. 1 have, e.g., a greater width 71 than the compensating elements 6 of the battery module 1 according to FIG. 2.

Furthermore, the battery module 1 according to FIG. 2 and the battery module 1 according to FIG. 3 each have an identical total width 10 of the battery module 10.

The battery modules 1 shown in FIGS. 2 and 3 in each case have been produced using a method according to the invention.

At this point, it should also be noted that the compensating elements 6 of a battery module 1 can also have different widths 71 and/or different deformabilities 72. For this purpose, a first compensating element 61 having a first width 711 and/or a first deformability 721 is arranged in particular between two battery cells 21 arranged directly adjacent to one another, the applied forces 41, 42 of which form a first sum. Furthermore, a second compensating element 62 having a second width 712 and/or a second deformability 722 is arranged in particular between two battery cells 21 arranged directly adjacent to one another, the applied forces 41, 42 form a second sum. In this case, the first sum is greater than the second sum and the first width 711 is smaller than the second width 721, or the first deformability 721 is smaller than the second deformability 722. FIG. 1 shows at least the reference characters of one such embodiment.

1. A method for producing a battery module (1) comprising a plurality of prismatic battery cells (2), and/or a plurality of battery cells (2) in the form of pouch cells,
wherein, in a first method step, a force (4) acting on a respective battery cell (2) is detected in order to form a defined width (3, 30) of the battery cell (2), and
wherein, in a second method step, the plurality of battery cells (2) are arranged adjacent to one another in a longitudinal direction (5) of the battery module (1), and
a compensating element (6) is furthermore arranged between two battery cells (21) arranged directly adjacent to one another, wherein
a width (71) and/or a deformability (72) of the compensating element (6) is formed such that, when a defined total width (10) of the battery module (1) is formed, a defined force (40) acts on a respective battery cell (2).

2. The method according to claim 1, wherein the force (4) acts on largest lateral surfaces (22) of the respective battery cell (2).

3. The method according to claim 1, wherein the force (4) is applied by two plates (45), wherein the respective battery cell (2) is arranged between the two plates (45).

4. The method according to claim 1, wherein, in the first method step, the respective force (4) acting on a battery cell (2) is also stored as belonging to this respective battery cell (2) and, in the second method step, the respective force (4) acting on a battery cell (2) is also read out and associated with this respective battery cell (2).

5. The method according to claim 4, wherein the respective force (4) acting on a battery cell (2) belonging to this battery cell (2) is stored in a database (8) or on the battery cell (2).

6. The method according to claim 1, wherein compensating elements (6) having different widths (71) and/or deformabilities (72) are arranged, wherein a first compensating element (61) having a first width (711) and/or a first deformability (721) is arranged between two battery cells (2), whose applied forces (4, 41, 42) form a first sum, and a second compensating element (62) having a second width (712) and a second deformability (722) is arranged between two battery cells (2), whose applied forces (4, 41, 42) form a second sum, wherein
the first sum is greater than the second sum, and
the first width (711) is smaller than the second width (712), and/or
the first deformability (721) is less than the second deformability (722).

7. The method according to claim 1, wherein compensating elements (6) having identical widths (713) and/or deformabilities (723) are arranged, wherein
a total force is first formed as a sum of all forces (4) acting on the respective battery cells (2), and the identical widths (713) and/or deformabilities (723) are then determined as a function of the defined total width (10) of the battery module (1).

8. The method according to claim 7, wherein the formation of the total force also comprises a calculation of an average force (4), and the defined total force is calculated as a product of the average force (4) and the number of battery cells (2).

9. A battery module comprising a plurality of battery cells (2) produced according to claim 1.

10. The method according to claim 1, wherein the plurality of battery cells (2) are lithium ion battery cells (20).
